(19) United States
(12) Patent Application Publication
(10) Pub. No.: US 2026/0233744 A1
(43) Pub. Date: Aug. 13, 2026

(54) SYSTEM AND METHOD FOR IMPROVING SENSOR PERCEPTION

(71) Applicant: Torc Robotics, Inc., Blacksburg, VA (US)

(72) Inventor: Akshay Pai Raikar, Austin, TX (US)

(21) Appl. No.: 19/050,539

(22) Filed: Feb. 11, 2025

(51) Int. Cl. B60W 40/02; B60W 60/00

(52) U.S. Cl. CPC B60W 40/02; B60W 60/0016; B60W 2300/125; B60W 2420/403; B60W 2420/408; B60W 2555/20

(57) ABSTRACT

A system for improving sensor perception is provided. The system includes at least one sensor configured to be located on a vehicle. The at least one sensor includes a field-of-view. The system includes a polarization unit, and a processing device in communication with the at least one sensor and the polarization unit. The processing device is configured to execute instructions stored in a memory to perform operations including detecting, with the at least one sensor, a degraded perception of an environment around the vehicle based on conditions in the environment external to the vehicle. The operations include actuating the polarization unit to apply a polarization effect to the at least one sensor to improve the degraded perception of the at least one sensor.

### TECHNICAL FIELD

The field of the disclosure relates to improving sensor perception and, in particular, to a system for improving sensor perception when environmental conditions around the vehicle create a degraded perception by the sensor.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

Various environmental conditions can be encountered by the vehicle as it travels along its route. For example, the vehicle can travel through rainy or snowy conditions. Depending on the intensity of the conditions, the perception of the sensors on the vehicle may be degraded. For example, rainy conditions can result in pooling of water on the road and/or mist rising up from other vehicles, which can at least partially conceal road markings and/or other vehicles on the road. Similarly, snow can cover road markings and signs, and heavy snowfall can at least partially conceal other vehicles on the road. The degraded perception of the vehicle sensors can reduce the overall confidence in the decision-making process of the vehicle (and/or the driver if the vehicle is semi-autonomous or non-autonomous), resulting in an increased risk associated with operating the vehicle.

Accordingly, there exists a need for a system and a method of improving sensor perception to overcome or reduce the degraded perception performance of sensors during various environmental conditions and/or weather events. These and other needs are met by the exemplary system for improving sensor perception discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for improving sensor perception is provided. The system includes at least one sensor configured to be located on a vehicle. The at least one sensor includes a field-of-view. The system includes a polarization unit, and a processing device in communication with the at least one sensor and the polarization unit. The processing device is configured to execute instructions stored in a memory to perform operations, including detecting with the at least one sensor, a degraded perception of an environment around the vehicle based on conditions in the environment external to the vehicle. The operations include actuating the polarization unit to apply a polarization effect to the at least one sensor to improve the degraded perception of the at least one sensor.

In some embodiments, the conditions can include at least one of snow, heavy rain, or sand, in the environment. In some embodiments, the degraded perception can include reduced visibility of a roadway and/or lane markings on the roadway due to the conditions in the environment. In some embodiments, the degraded perception includes at least one of blurriness or haziness to the field-of-view of the at least one sensor. In some embodiments, the operations can include detecting a luminosity of the environment and determining whether the detected luminosity is above a predetermined luminosity threshold. In some embodiments, the predetermined luminosity threshold can be about, e.g., 400 lux.

In some embodiments, detecting with the at least one sensor a degraded perception of the environment can include detecting an amount of ambient light received by the at least one sensor and determining whether the detected amount of ambient light received by the at least one sensor is above a predetermined ambient light threshold. In some embodiments, detecting with the at least one sensor a degraded perception of the environment can include detecting a continuity value for lane markings on a roadway along which the vehicle is traveling, and determining whether the detected continuity value is above a predetermined continuity value threshold.

In some embodiments, the polarization unit can include a passive polarization filter movably disposed relative to the field-of-view of the at least one sensor. In such embodiments, the operations can include moving the passive polarization filter into a deployed position within the field-of-view of the at least one sensor, and moving the passive polarization filter into a stowed position offset from the field-of-view of the at least one sensor.

In some embodiments, the polarization unit can include an active polarization filter capable of being actuated to selectively modify a polarization effect applied to the at least one sensor. In such embodiments, the operations can include determining a level of the degraded perception of the environment, and modifying the polarization effect applied by the active polarization filter to the at least one sensor. In such embodiments, the operations can include dynamically modifying the polarization effect applied by the active polarization filter to the at least one sensor based on determining of the level of the degraded perception of the environment.

In some embodiments, the polarization effect can be dynamically modified in real-time. The active polarization filter can reduce glare, reflections, and scattered light via polarization filtering, dynamic polarization modulation, and adaptive contrast enhancement. In some embodiments, the at least one sensor can include a camera. In some embodiments, the vehicle can be, e.g., an autonomous vehicle, a semi-autonomous vehicle, a non-autonomous vehicle, or the like.

In another aspect, an exemplary computer-implemented method for improving sensor perception is provided. The method includes detecting, with at least one sensor configured to be located on a vehicle, a degraded perception of an environment around the vehicle based on conditions in the environment external to the vehicle. The method includes executing instructions stored in a memory with a processing device in communication with the at least one sensor and a polarization unit to perform operations including actuating the polarization unit to apply a polarization effect to the at least one sensor to improve the degraded perception of the at least one sensor.

In some embodiments, the polarization unit can include a passive polarization filter movably disposed relative to the field-of-view of the at least one sensor. In such embodiments, the operations can include moving the passive polarization filter into a deployed position within the field-of-view of the at least one sensor, and moving the passive polarization filter into a stowed position offset from the field-of-view of the at least one sensor.

In some embodiments, the polarization unit can include an active polarization filter capable of being actuated to selectively modify a polarization effect applied to the at least one sensor. In such embodiments, the operations can include determining a level of the degraded perception of the environment, and modifying the polarization effect applied by the active polarization filter to the at least one sensor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for improving sensor perception.

FIG. 7 is a flowchart of a method for improving sensor perception.

FIG. 8 is an example of snowy conditions in an environment that result in degraded perception of the environment with a sensor on a vehicle.

FIG. 9 is an example of rainy conditions in an environment that result in degraded perception of the environment with a sensor on a vehicle.

FIG. 10 is an example of an environment captured during hazy conditions by a degraded sensor of a vehicle without polarization.

FIG. 11 is an example of an environment of FIG. 10 captured during hazy conditions by a sensor of a vehicle with polarization.

FIG. 12 is block diagram of an exemplary polarization unit for improving sensor perception, including a circular polarization filter.

FIG. 13 is a schematic side view of a passive polarization unit of an exemplary system for improving sensor perception, including a passive polarization filter in a retracted or stowed position.

FIG. 14 is a schematic side view of a passive polarization unit of an exemplary system for improving sensor perception, including a passive polarization filter in a deployed position.

FIG. 15 is a block diagram of an active polarization unit of an exemplary system for improving sensor perception.

FIG. 16 is a schematic perspective view of an active polarization unit of an exemplary system for improving sensor perception, including an active polarization filter in an off state.

FIG. 17 is a schematic perspective view of an active polarization unit of an exemplary system for improving sensor perception, including an active polarization filter in an on state with voltage applied.

FIG. 18 is a block diagram and flowchart of an exemplary system for improving sensor perception, including a polarizer control circuit.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for improving sensor perception includes a passive and/or active polarization unit capable of being selectively actuated into operation to improve the sensor perception when a degraded sensor operation is detected. As an example, the system can be operated in snow-related white outs and/or heavy rain conditions, improving the perception of the sensor through polarization and reducing the risk of continued operation of the vehicle in the environmental conditions. Even if the environmental conditions are extreme enough to warrant a safety maneuver by the vehicle, e.g., pulling over onto a shoulder, the exemplary system provides the vehicle with improved sensor perception to determine if and when a stop on the shoulder can be performed.

In particular, autonomous driving (and, in some instances semi-autonomous and non-autonomous driving) can rely heavily on robust and accurate sensor systems to navigate safely and efficiently. In the vehicles, cameras can particularly play a crucial role in detecting and responding to the environment, including lane markings, obstacles, pedestrians, and other traffic participants. However, adverse weather conditions, such as heavy rain and snow (and even sand or dust storms), can significantly impede the performance of the vehicle cameras, leading to reduced visibility and increased risk of accidents. Degraded image quality in adverse weather conditions can lead to reduced accuracy and reliability, compromising the safety and effectiveness of autonomous driving systems. The system includes polarizers to improve camera visibility in various environmental conditions (including heavy rain and snow whiteouts), enabling enhanced safety and reliability in autonomous, semi-autonomous and non-autonomous driving applications.

As used herein, the terms whiteout, white-out, or milky weather can refer to a weather condition in which the contours and/or landmarks in a snow-covered zone become almost indistinguishable. The term can similarly be used for rainy, sandy or dusty conditions. For example, the terms can also be applied when visibility and contours are greatly reduced by sand during a sandstorm. In these conditions, the horizon disappears (or substantially disappears) from view, while the sky and landscape appear featureless, leaving no or minimal points of visual reference by which to navigate. In these conditions, there may be an absence of shadows because the light arrives in equal measure from all possible directions. In some conditions, water or snow can pool or collect on the roadway, resulted in occluded lane markings or road boundaries. In some embodiments, a lack of continuity in lane markings can indicate a degraded perception of the vehicle sensors. In some embodiments, the weather conditions can result in a blur to visibility, thereby reducing the overall confidence level of the vehicle sensors. In some embodiments, the system can determine that a whiteout condition is in effect if the horizon cannot be detected by the vehicle sensors. Thus, the conditions refer to instances where visibility is greatly reduced for sensors of the vehicle.

Autonomous, semi-autonomous and non-autonomous driving systems can use a variety of sensors, including cameras, LiDAR, radar, and/or ultrasonic sensors, to perceive the environment. These sensors assist the vehicle in perception of the surrounding environment, and can be used to at least partially guide the vehicle along the desired route in a safe manner. Cameras of the vehicle can be particularly vulnerable to adverse weather conditions, which can lead to reduces visibility, increased noise, and/or decreased accuracy. In terms of reduced visibility, as an example, heavy rain or snow can at least partially obscure the field-of-view of the camera, making it challenging to detect obstacles or lane markings. In terms of increased noise, as an example, scattered light and reflections can add noise to the image, reducing accuracy and reliability. In terms of decreased accuracy, as an example, degraded image quality can lead to reduced accuracy in object detection, tracking, and classification.

As further examples, in heavy rain, the raindrops and spray from other vehicles can cause glare, reflections, and/or scattered light. Glare can be in the form of direct reflection of light from raindrops, which overpower the actual image. Reflections can be in the form of indirect reflections from surrounding surfaces, adding noise to the image. Scattered light can be in the form of diffused light from raindrops, reducing image contrast and clarity.

In snow whiteouts, the snowflakes can cause multiple scattering, and/or diffusion. Multiple scattering can be in the form of light being scattered in multiple directions, leading to a uniform whiteout effect. Diffusion can be in the form of light being diffused, reducing image contrast and clarity.

Each of the above-noted effects (alone or in combination) can significantly degrade the performance of the autonomous driving systems, leading to reduced safety and reliability. The net effect of the degradation in sensors can cause the autonomous driving system to exit the nominal conditions of operations (operational design domain) that are defined at the outset of every autonomous driving solution's development. Typically, this exit from nominal conditions of operation leads to a situation where the autonomy system enters a degraded mode and travels to safety. In general, one type of minimal risk condition that the autonomy system will attain is traveling off the road to the shoulder and stopping until nominal weather conditions return.

However, in order to perform the minimal risk condition or maneuver, the autonomy system may need to relay on the degraded sensor input explained above. The exemplary system includes a polarizing filter that improves the degraded sensor perception to allow the vehicle to either perform the minimal risk condition, or continue driving along the route. In some embodiments, the polarizing filter can help reduce glare and enhances the contrast and saturation of the colors in the images or video captured by the sensor. The polarizing filter can block specific wavelengths of light, which can help reduce reflections and makes colors appear more vibrant.

As discussed herein, the polarizing filter can be a passive polarizing filter, an active polarizing filter, or both. A passive polarizing filter can be used in hazy and/or glare filled environments described herein, and can be actuated to selectively position the polarizing filter in the field-of-view of the sensor when the polarization effect is desired. In some embodiments, a shutter-like mechanism can be used to deploy the polarizing filter when the autonomy system determines that the polarizing effect is needed or would be helpful. An active polarizing filter can be dynamically actuated to vary and adjust the level of polarization applied to the sensor based on the environmental conditions. The active polarizing filter can therefore be customized in real-time to ensure optimal polarization is achieved.

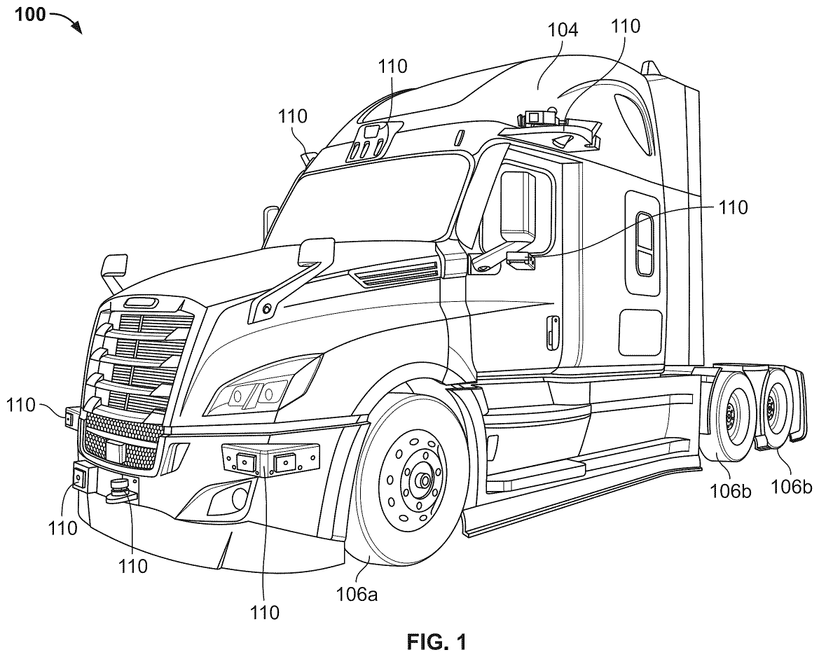

Various embodiments in the present disclosure are described with reference to FIGS. 1-18 below.

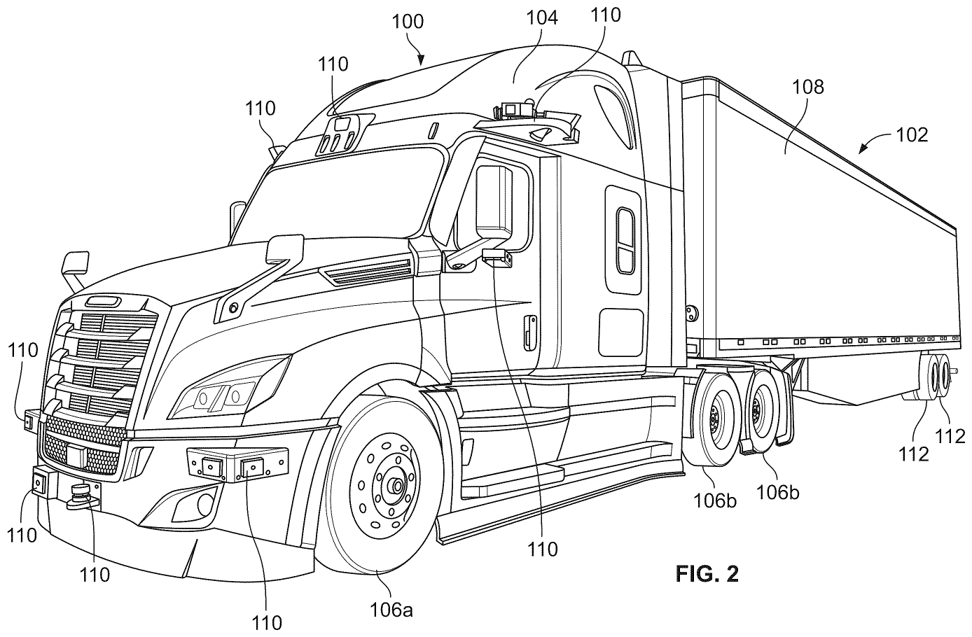

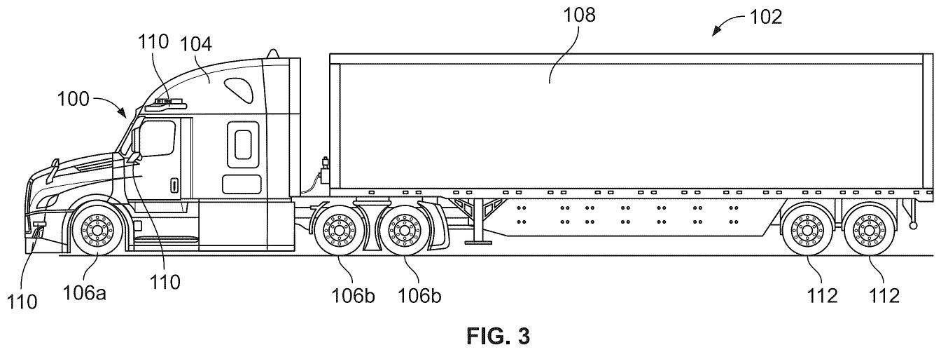

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

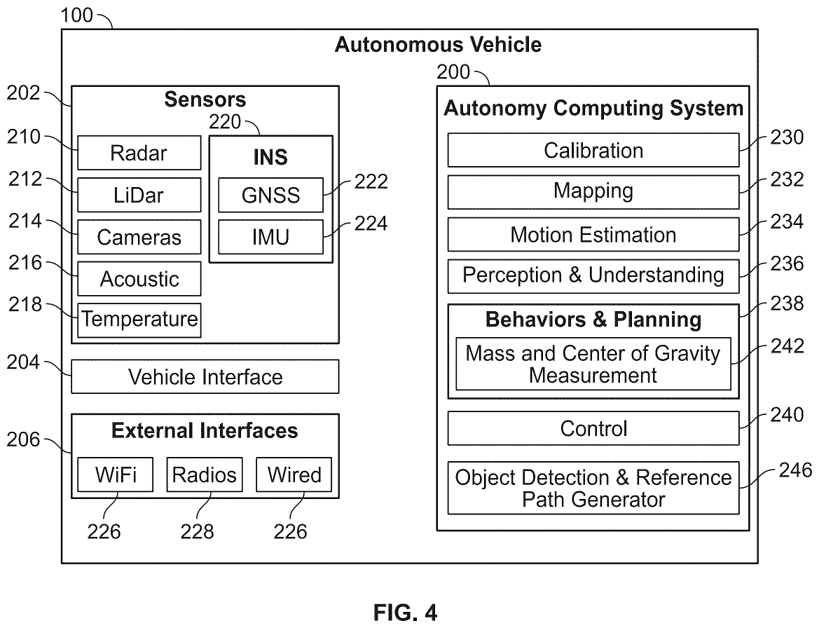

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

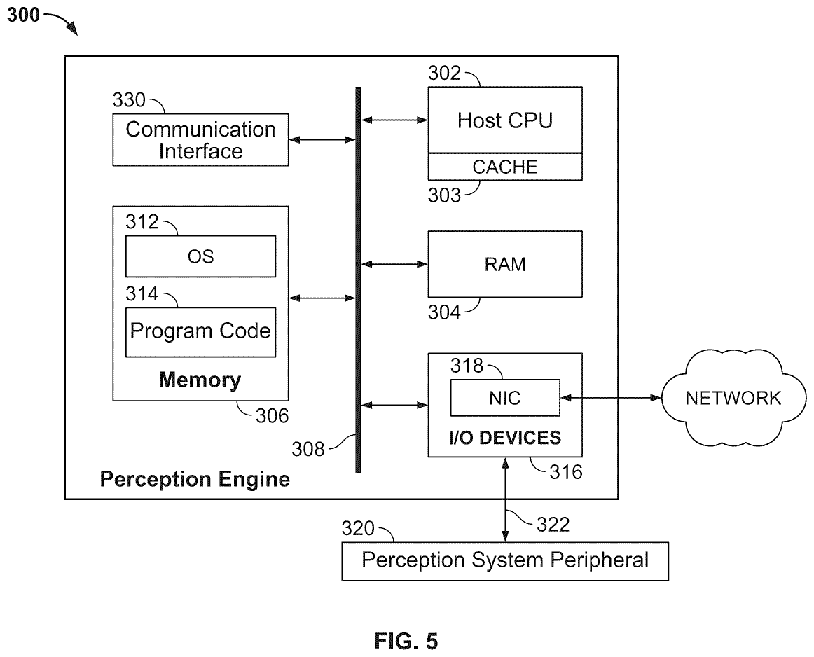

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

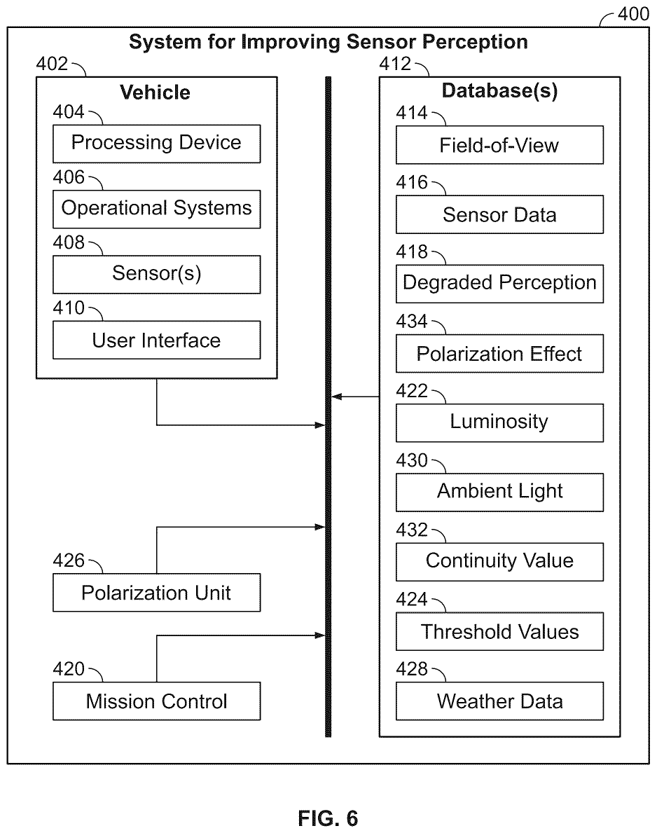

FIG. 6 is a block diagram of an exemplary system 400 for improving sensor perception. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data from sensors 408 of the vehicle 402. The vehicle 402 can include one or more operational systems 406 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 408 (e.g., sensors 202) for detecting the environment and objects within the environment around the vehicle 402. The vehicle 402 can include a variety of sensors 408, such as cameras, LiDAR, radar, infrared, or the like. Although not limited to such implementation, the exemplary system 400 is discussed herein as being focused on improving perception of cameras of the vehicle 402 to ensure safe travel of the vehicle 402 during difficult weather conditions. Each sensor 408 (including cameras) includes a field-of-view 414 in which data can be captured.

In general, the cameras of the vehicle 402 can be used to perceive, e.g., road markings, road signs, surrounding vehicles, surrounding pedestrians, objects on or around the road, combinations thereof, or the like. This data can be saved as sensor data 416 in a database 412 of the system 400. If one or more areas of the field-of-view 414 of the sensors 408 are occluded due to weather conditions, such as snow, rain, sand, dust, or the like, the sensor data 416 can be incomplete or inaccurate, resulting in degraded perception 418 of the sensors 408. In particular, the processing device 404 can detect when the sensor data 416 is degraded based on, e.g., a comparison to previous historical data and detection of lower quality or clarity of the sensor data 416.

In some embodiments, the system 400 can implement a neural network based object detection mechanism or algorithm to identify lane markings and other road features. These road features are detected and assigned bounding boxes with a probability score, e.g., a value between 0-100%. The higher the probability score, the more certain the system 400 is about the detected feature. In the case of input image quality degradation due to environmental factors, the change in conditions can occur over a short duration or any other predetermined period of time, e.g., 10 minutes, or the like. The system 400 can keep track of the drop or change in the probability score in the time period in which the image quality degradation changes due to the environmental conditions. Since the neural network based detection is an empirical system, the threshold for the probability score can be predetermined or programmed into the system 400. For example, if the system 400 detects an average percentage probability value reduction of 40% or more over a predetermined time period, e.g., 10 minutes, the system 400 can determine that the input quality of the image is degraded due to the environmental conditions, necessitating the degraded perception 418 indication and modified operation of the system 400. However, it should be understood that the threshold for the probability score reduction and the predetermined period of time during which the probability score reduction occurs can vary depending on system 400 preferences. In some embodiments, the system 400 can implement a probability trained multi-task object detection model which, in addition to detection of objects and features, is also capable of distinguishing between degraded and non-degraded input image frames. These features can be incorporated into, e.g., the processing device 404, the polarization unit 426, the operational systems 406, combinations thereof, or the like, or can be a separate probability unit of the system 400.

As an example, if the sensors 408 previously detected road or lane markings in an operating environment where sensor 408 perception was not degraded and, then, due to detected weather conditions, the road or lane markings are not detected by the sensors 408, the processing device 404 can indicate that degraded perception 418 is reached. In such embodiments, the sensor data 416 can be analyzed by the processing device 404 to determine a continuity value 432 for the lane markings on the roadway. If the continuity value 432 is below a threshold value 424, the system 400 can determine that the sensors 408 are operated with a degraded perception and use of the polarization unit 426 is needed. In some embodiments, an empirical threshold value can be used for the continuity value 432. For example, if the probability value of detection is reduced to below 50% or more than 200 times per minute, the degraded perception is identified and initiation of the polarization unit 426 use can be performed. However, different probability value thresholds for the continuity value 432 can be used, depending on the requirements of the system 400. As an example, if the sensors 408 are capable of detecting lane markings at a distance of 400 m in front of the vehicle 402 and no or minimal lane markings are detected at a distance in the 0 -200 m range, the system 400 can determine that whiteout conditions are met, indicating degraded perception of the sensors 408.

In some embodiments, the degraded perception 418 can be, e.g., reduced visibility of the roadway and/or lane markings due to weather conditions, blurriness or haziness to the field-of-view of the sensor 408, or the like. In some embodiments, the system 400 can receive weather data 428 (current and future) from the sensors 408 and/or an external source to inform the vehicle 408 of the current weather conditions around the vehicle 402 or the future weather conditions expected to be encountered along a mission route. The weather data 428 can be used to confirm to the processing device 404 that weather conditions created the current degraded perception 418, or will potentially create a future degraded perception 418, for the sensors 408.

The vehicle 402 includes a user interface 410 (e.g., vehicle interface 204) configured to receive/transmit and display data for operation of the system 400, as well as the vehicle 402 itself. The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be located at mission control 420 (or any other external location proximate a control unit) external to the vehicle 402 and in communication with the vehicle 402. In some embodiments, the database 412 can be located on the vehicle 402 itself. In some embodiments, one or more portions of the database 412 can be distributed across components of the system 400. The database 412 can store information relating to current operation of the sensors 408 and improvement of the sensor 408 perception.

In some embodiments, the system 400 can determine the luminosity 422 level of the environment around the vehicle 402 using the sensors 408. In particular, the sensors 408 detect the luminosity 422 level and the processing device 404 determines if the detected luminosity 422 level is above a predetermined luminosity threshold value electronically stored in the threshold values 424 of the database 412. In some embodiments, the luminosity threshold value can be about, e.g., 400 lux, or the like. The luminosity 422 level determination can be used to indicate to the vehicle 402 if the polarization unit 426 can be implemented to improve the sensor 408 perception.

In particular, the polarization unit 426 can generally be implemented during the daytime (not at night) to ensure optimal operation During nighttime hours, use of the polarization unit 426 would attenuate the low ambient light available and, therefore, the polarization unit 426 is not usable below a predetermined luminosity 422 level. Certain luminosity conditions are required for the polarization filter to accurately improve the sensor 408 perception. A luminosity 422 level of 400 lux or higher indicates sunset and sunrise conditions, as well as daytime conditions, indicating that the polarization unit 426 can operate. If the sensors 408 detect that the luminosity 422 level is below 400 lux, e.g., below 250 or 200 lux, a determination can be made that it is too dark to operate the polarization unit 426. Specifically, if the polarization unit 426 was operated in sub-400 lux conditions, the sensor 408 would have trouble detecting features on the roadway. Thus, the luminosity 422 threshold must be met for the polarization unit 426 to be selectively used.

In some embodiments, the system 400 can rely on the sensors 408 to detect an amount of ambient light 430 received by the sensors 408. The processing device 404 can process this sensor data 416 to determine if the ambient light 430 level is above a predetermined ambient light threshold value 424. The weather data 428 can provide information to the vehicle 402 indicating that the weather conditions (current or future) will result in lower ambient light 430 and degraded perception. In some embodiments, an ambient light threshold value 424 can be about, e.g., 30 lux, or the like. This ambient light threshold value 424 is indicative of the threshold for twilight. Any ambient light measurement below this amount indicates that the environment conditions are degraded due to weather conditions, and the polarization unit 426 can be used to improve the sensor 408 perception. The system 400 generally is not usable below the 30 lux threshold. However, the 30 lux condition in conjunction with input quality degradation and weather data can be used to determine triggering conditions for deploying the polarization unit 426. In some embodiments, the operating range for the polarization unit 426 can be in an ambient light range of, e.g., 30-80 lux, inclusive.

In some embodiments, detecting with the at least one sensor a degraded perception of the environment can include detecting an amount of ambient light received by the at least one sensor and determining whether the detected amount of ambient light received by the at least one sensor is above a predetermined ambient light threshold. In some embodiments, the system 400 can measure the degradation of the output of the perception and object detection software using, e.g., a mean average precision (mAP) metric, such as the one discussed in https://www.v7labs.com/blog/mean-average-precision, or the like. In some embodiments, the mAP values can be tracked over time by the system 400 to indicate when the lux measurement indicates that the vehicle 402 is in a zone of low and diffuse light. In some embodiments, the threshold for mAP can be about, e.g., 0.7. As discussed herein, luminosity refers to the unit of measurement of the light and, for purposes of the system 400, is used to measure the units of ambient light available. mAP is a metric used to track accuracy of object detection.

The system 400 can therefore analyze the sensor 416 for a variety of values and thresholds to determine if the degraded perception 418 of one or more sensors 408 is detected. In some embodiments, only one or more of the threshold values 424 must be surpassed before the polarization unit 426 is activated to operate. In some embodiments, each of the luminosity 422, ambient light 430, and continuity value 432 thresholds must be surpassed before the polarization unit 426 can be activated to operate.

It should be understood that the polarization unit 426 can be selectively activated for each individual sensor 408 as needed depending on the data 416 processed from each individual sensor 408. Thus, the polarization unit 426 can be used to regulate polarization of each individual sensor 408. The system 400 can store the polarization effect 434, e.g., polarization level, applied to each sensor 408. In some embodiments, the polarization unit 426 can be a passive unit that applies a predetermined level of polarization to the sensor 408. In some embodiments, the polarization unit 426 can be an active unit that can be dynamically and independently operated to optimize the polarization effect 434 applied to each sensor 408. Optimized improvement of the sensor 408 perception can thereby be achieved.

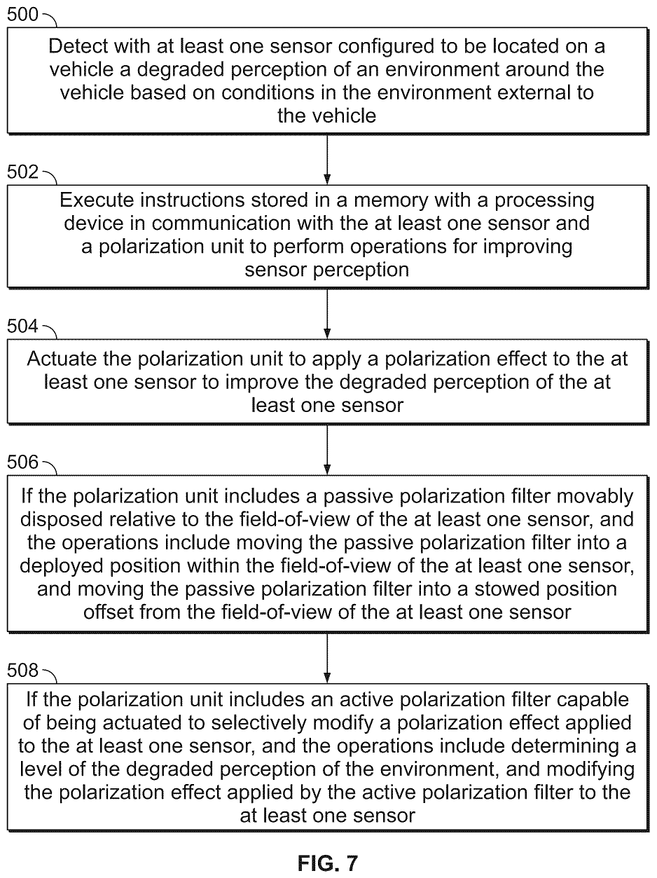

FIG. 7 is a flowchart of a method of improving sensor perception by the exemplary system 400 discussed herein. At 500, a degraded perception of an environment around the vehicle is detected with at least one sensor configured to be located on the vehicle based on conditions in the environment external to the vehicle. At 502, instructions stored in a memory are executed with a processing device in communication with the sensor and a polarization unit to perform operations for improving sensor perception. At 504, the polarization unit is actuated to apply a polarization effect to at least one sensor to improve the degraded perception of the sensor.

At 506, if the polarization unit includes a passive polarization filter movably disposed relative to the field-of-view of the sensor, the operations can include moving the passive polarization filter into a deployed position within the field-of-view of the sensor, and moving the passive polarization filter into a stowed position offset from the field-of-view of the at least one sensor. In particular, if polarization is needed, the polarization filter can be deployed until the system determines that polarization is no longer needed, at which point the polarization filter can be stowed.

At 508, if the polarization unit includes an active polarization filter capable of being actuated to selectively modify a polarization effect applied to the sensor, the operations can include determining a level of the degraded perception of the environment, and modifying the polarization effect applied by the active polarization filter to the sensor. The voltage supply to the active polarization filter can be inversely proportional to the scale of degradation. Thus, regulating the voltage supply can affect the level of polarization applied to the sensor. The specific relationship between polarization effect and voltage supply level can be determined using empirical data based on the desired operation of the system.

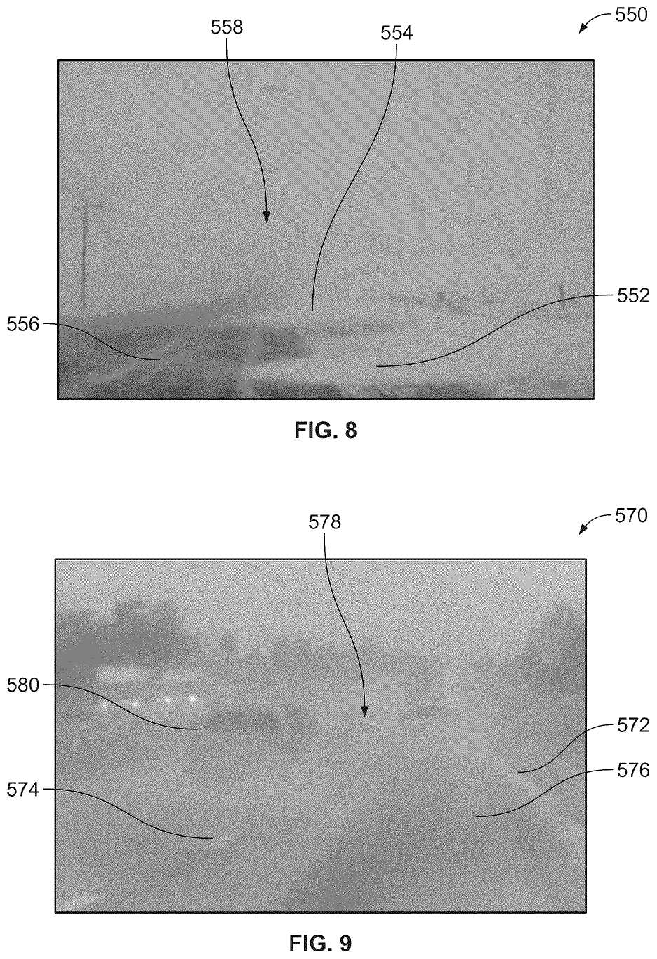

FIG. 8 is an example of an environment 550 in which degraded perception by the vehicle sensor occurs due to the weather conditions in the environment 550. In particular, the snowy conditions in the environment 550 produce patches 552, 554 covering large portions of the roadway 556. Similarly, falling snow 558 produces a haze above to roadway 556 which reduces the ability to sense/view the roadway 556 surface at longer distances away from the vehicle 402. If the luminosity conditions are met, the weather conditions in the environment 550 warrant implementation of the polarization unit of the system.

FIG. 9 is an example of an environment 570 in which degraded perception by the vehicle sensor occurs due to the weather conditions in the environment 570. In particular, the rainy conditions in the environment 570 result in pooling water 572 that occludes some lane markings 574 of the roadway 576. Mist 578 rising from the roadway 576 and other vehicles 580 further reduces the ability to sense/view the roadway 576 surface at longer distances away from the vehicle 402. If the luminosity conditions are met, the weather conditions in the environment 570 warrant implementation of the polarization unit of the system.

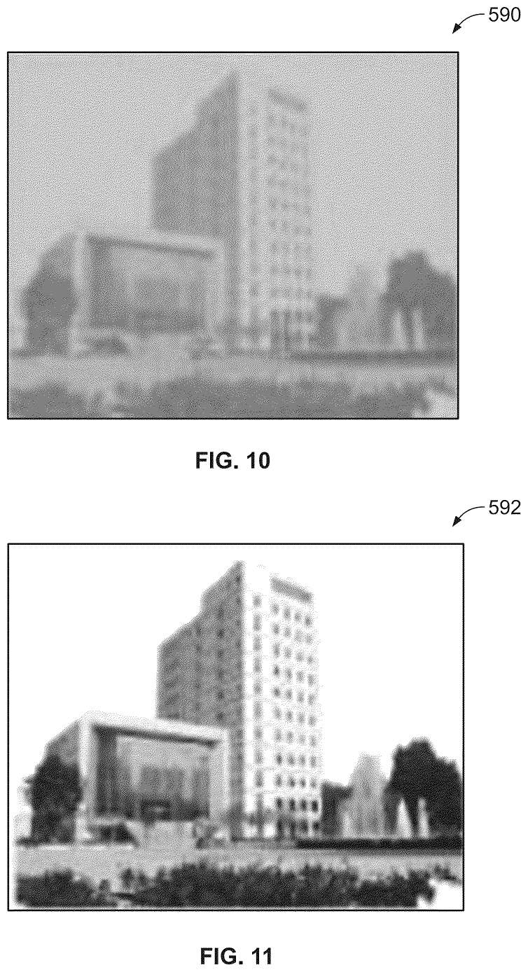

FIG. 10 is an image 590 of an environment captured by a sensor during hazy conditions, resulting in blurriness and low perception of the environment. The image 590 therefore shows a degraded perception of the environment by the sensor. FIG. 11 is an image 592 of the same environment as shown in FIG. 10, except after implementation of the exemplary polarization unit. The details of the environment in FIG. 11 are clearer more accurate, ensuring that the sensor data with the improved perception can be used to safely regulate operation of the vehicle in an accurate manner.

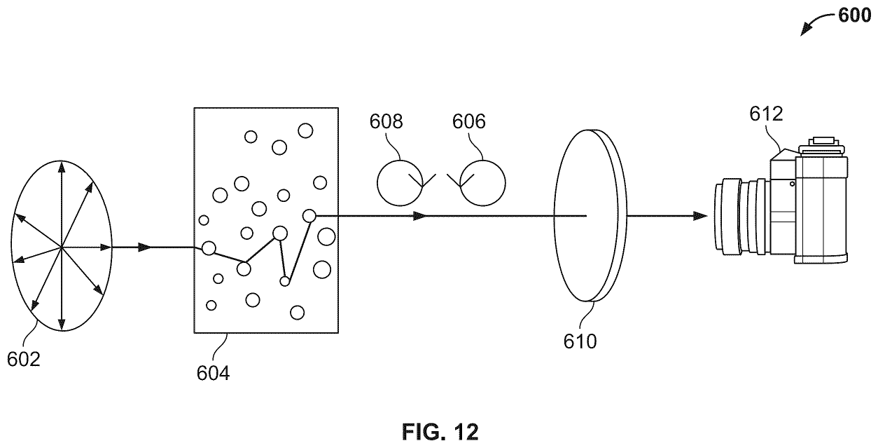

FIG. 12 is a block diagram of an exemplary polarization unit 600 for applying a polarizing effect on raw image data captured during white out or rainy conditions. Natural light 602 passes through raindrops 604 in the environment, resulting in diffusion of the light 602. Circular polarized light (e.g., left circularly polarized light 606 and right circularly polarized light 608) pass through a circular polarization filter 610 prior to entry into a lens of a sensor 612, e.g., a camera. In some embodiments, the polarization filter 610 blocks specific wavelengths of light, which helps to reduce reflections and makes colors more vibrant in the image captured by the sensor 612. In some embodiments, the polarization filter 610 blocks the green wavelength (and potentially partially the blue wavelength) to help reduce reflections and make colors more vibrant in the image captured by the sensor 612. Thus, a more accurate image can be captured by the sensor 612 for analysis and use by the vehicle implementing the polarization unit 600.

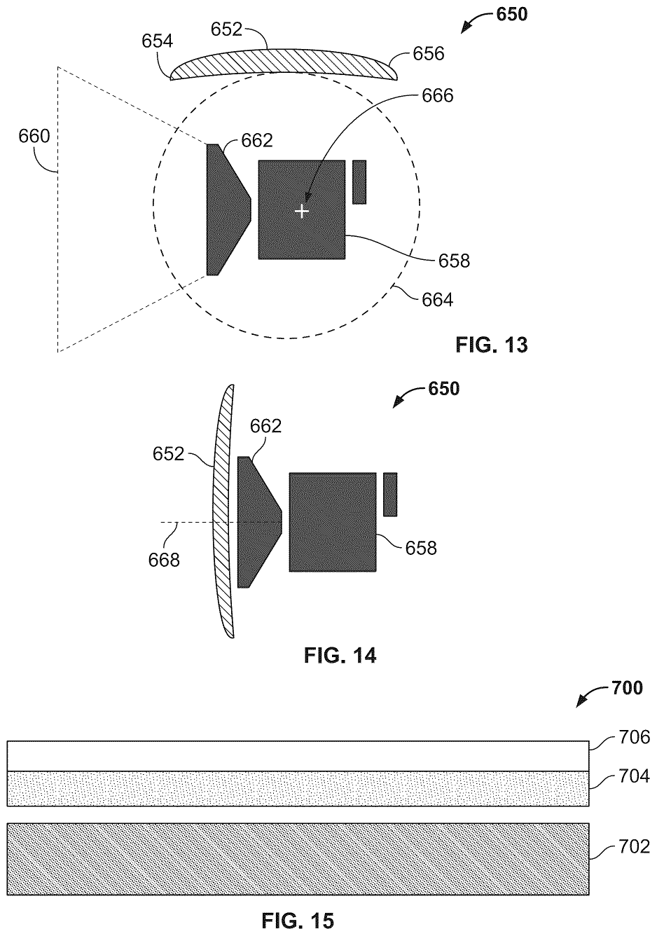

FIG. 13 is a schematic side view of a passive polarization unit 650 including a passive polarization filter 652 in a stowed position, and FIG. 14 is a schematic side view of the passive polarization unit 650 including the passive polarization filter 652 in a deployed position. The polarization filter 652 can define a substantially concave inwardly facing surface and a substantially convex outwardly facing surface extending between opposing ends 654, 656. It should be understood that the polarizing filter 652 can define a generally circular configuration.

The polarization unit 650 includes a sensor 658, e.g., a camera, with a field-of-view 660 of a lens 662 in which the sensor 658 can capture data. In some embodiments, the polarization unit 650 can include a drum-shaped enclosure 664 positioned at least partially around the sensor 658. The enclosure 664 can include, e.g., a transparent film, wall, or the like, through which data can be captured by the sensor 658. Thus, in the position illustrated in FIG. 13, the field-of-view 660 is not obstructed by the enclosure 664, and the sensor 658 can operate without polarization from the filter 652.

When polarization is needed, the enclosure 664 can be rotated about an axis 666 of rotation to selectively rotate the filter 652 into and out of the field-of-view 660. In some embodiments, the entire enclosure 664 can be rotated relative to the sensor 658 and the filter 652 can be coupled to the enclosure 664 to simultaneously rotate into the deployed position of FIG. 14. In some embodiments, the filter 652 can be slidable and/or rotatably coupled to the enclosure 664, and the filter 652 can be moved relative to the enclosure 664 into the deployed position of FIG. 14. In the deployed position, the central axis 668 of the lens 662 and the filter 652 can be substantially aligned. In the deployed position of FIG. 14, the light traveling through the filter 652 is polarized and captured by the sensor 658. Thus, the filter 652 reduces glare, reflections and scattered light due to weather conditions, and provides for a clearer and more accurate representation for processing and guidance of the vehicle. In some embodiments, the filter 652 can be part of a rigid arm assembly that is coaxially mounted to the camera/sensor housing or enclosure 664. A stepper motor in conjunction with the arm assembly can be used to rotate the filter 652 and align the filter 652 with the focal line of the camera or sensor 658.

In some embodiments, the polarization unit can be an active polarization unit. FIG. 15 is a block diagram of an active polarization unit 700 capable of being used with the exemplary system 400. The polarization unit 700 generally includes a sensor 702, e.g., a camera sensor lens, or the like. The polarization unit includes an active polarizing layer 704 disposed adjacent to the sensor 702, e.g., in the field-of-view of the sensor 702. The active polarizing layer 704 can be selectively actuated dynamically to generate the desired polarizing effect on the sensor 702.

The polarization unit 700 can include a retarding layer 706 disposed adjacent to the active polarizing layer 702. A key optical element of the polarization state manipulation can be the retarding layer 706, also known as a wave plate. The retarding layer 706 introduces a controlled phase difference or retardation between the orthogonal components of polarized light as it passed through the retarding layer 706. The retarding layer 706 modifies the polarization state of light, and can be used to convert linearly polarized light into elliptically or circularly polarized light. Retarders can be categorized based on the specific way they alter the polarization state and the mount of phase difference the retarder introduces. The most common type of retarders include quarter-wave plates and half-wave plates. A quarter-wave plate introduces a quarter-wavelength phase shift between the two orthogonal components of polarized light, and can be particularly useful for converting linearly polarized light into circularly polarized light, or vice versa. A half-wave plate introduces a half-wavelength phase shift, and is often used to rotate the plane of polarization of linearly polarized light. The retarder layer 706 can function in combination with the active polarizing layer 704 to ensure the desired degree of polarization is achieved.

The active polarization unit 700 improves the sensor 702, i.e., camera, visibility in adverse weather conditions. Unlike passive polarizers, which only filter out certain polarizations, the active polarization unit 700 can be dynamically adjusted to control the polarization state or effect to optimize image quality. This is achieved through twisted nematic liquid crystals, electro-optic materials, or other technologies that can modulate light polarization.

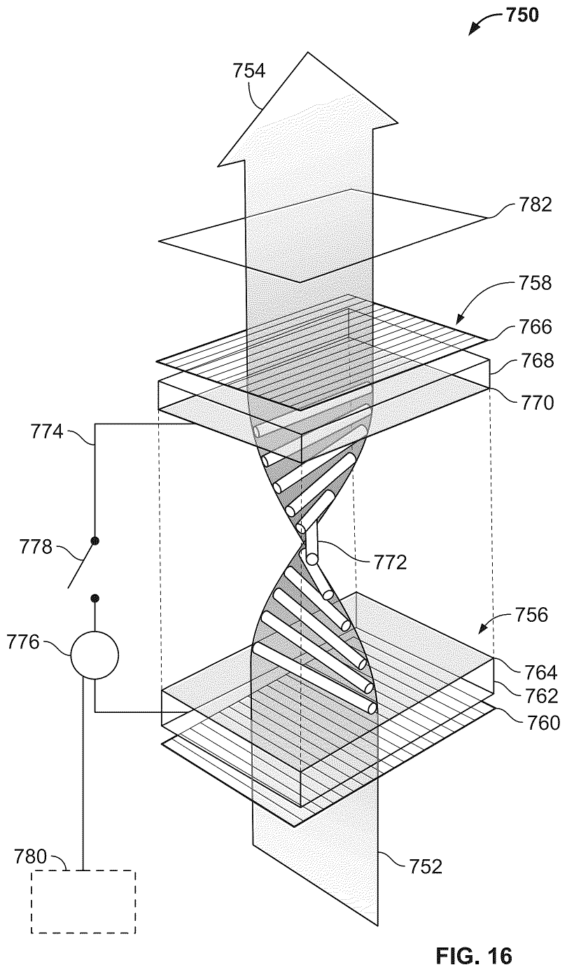

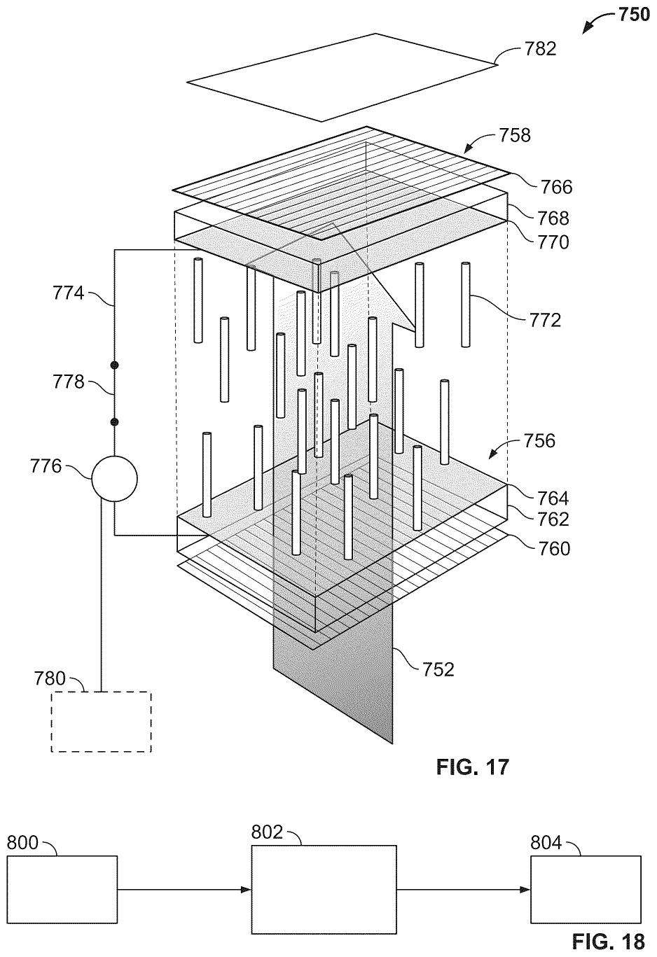

FIGS. 16 and 17 are schematic perspective views of an active polarization unit 750 capable of being incorporated into the exemplary system 400. In particular, FIG. 16 shows the active polarization unit 750 in an off state and FIG. 17 shows the active polarization unit 750 in an on state. The polarization unit 750 can be in the form of adaptive liquid crystals and/or twisted nematic liquid crystals. The polarization unit 750 is disposed ahead of the sensor aperture to selectively polarize the incoming signal. Initial light, e.g., input signal 752, generally passes through the active polarization unit 750 and outputs as an output light signal 754, which is polarized if the polarization unit 750 is in the on state. If the polarization unit 750 is in the off state, light does not pass through the polarization unit 750.

The active polarization unit 750 generally includes a first assembly 756 and a second assembly 758. The first assembly 756 includes a polarization layer 760, a glass substrate layer 762, and an electrode layer 764. The second assembly 758 also includes a polarization layer 766, a glass substrate layer 768, and an electrode layer 770. The first and second assemblies 756, 758 are separated by a nematic crystal twist 772. The first and second assemblies 756, 758 are electrically connected to each other by a circuit 774 which includes a voltage source 776 and a switch 778.

In the off position, the switch 778 can be opened to prevent voltage passage through the circuit 774. In the on position, the switch 778 can be closed to allow flow of voltage through the circuit 774. A controller 780 connected to the voltage source 776 and/or the switch 778 can be used to regulate the amount of voltage passing through the circuit 774, thereby adjusting the level of polarization effect applied to the input signal 752 based on the detected conditions outside of the vehicle, e.g., real-time adjustment of the polarization level/effect. The lens 782 of the sensor therefore receives a polarized output signal 754 if the active polarization unit 750 is activated into an on state. The polarization level can be actively adjusted based on an active/dynamic determination level of the whiteout conditions.

FIG. 18 is a block diagram and flowchart of an exemplary system for improving sensor perception, including a polarizer control circuit for an active polarization unit. In particular, the system includes a communication interface 800, e.g., a serial, CAN, Ethernet, or the like, connection. Based on the sensor data indicative of degraded perception, a determination by the processing device is made regarding the polarization effect required for optimized sensor detection/operation. The request for desired polarization is transmitted to a polarizer control circuit 802. The polarizer control circuit 802 determines the voltage supplied to the circuit to change the polarization effect. The change in voltage supplied affects the polarization effect created by a polarizer film 804.

Perception and sensing of the vehicle can include a module that will make the determination for the need to deploy the polarization unit and, in the case of active polarizers, to what extent polarization is applied. FIG. 18 illustrates the control circuit for deploying the polarizing module over the sensor, e.g., camera. The signal can be communicated to the polarizer control circuit via a serial/CAN or Ethernet protocol, and the appropriate voltage/current can be applied to the drive motor to rotate and align the polarizing filter with the sensor focal point.

The active polarization unit provides several advantages. The active polarization unit provides dynamic polarization control. In particular, active polarizers can adapt to changing lighting conditions and optimize polarization for improved image quality in real-time or substantially real-time. The active polarization unit provides improved glare reduction. In particular, active polarizers can reduce glare from raindrops or snowflakes by dynamically adjusting their polarization state. The active polarization unit provides enhanced contrast. In particular, active polarizers can improve image contrast by reducing scattered light and reflections.

The active polarization unit can reduce glare, reflections, and/or scattered light in various ways. In some embodiments, polarization filtering can be used. In particular, active polarizers can filter out horizontally polarized light, which is commonly associated with glare and reflections. In some embodiments, dynamic polarization modulation can be used. In particular, active polarizers can modulate their polarization state to match the changing polarization of light in adverse weather conditions. In some embodiments, adaptive contrast enhancement can be used. In particular, active polarizers can adjust their polarization state to optimize image contrast and reduce scattered light.

The active polarization unit can include a control circuit where the control commands can be provided by the perception overseer module within the perception components of the autonomy stack. Once the system can identified that the vehicle has entered a situation with inclement weather where visibility has fallen below acceptable thresholds, the polarization unit can be activated. In particular, the system can trigger either the passive or active polarizing mechanism. In the case of the passive circular polarizing filter, the enclosure/housing (or the filter) can be rotated into the field-of-view of the sensor. In the case of the active polarizing filter, voltage can be supplied to achieve the desired polarization effect/level.

In both the passive and active embodiments, additional post-processing can be performed on the output signal to improve the quality of the final input image using, e.g., a wavelet transform-based algorithm. Wavelet based transform is an algorithm in the industry used for image compression and filtering. High frequencies typically represent noise, and the wavelet transform can be used to perform smoothing and thresholding on the image. The low frequencies typically represent important features in the image that are to be enhanced with the processing.

Various steps of post-processing of the output signal can be performed by the system. The steps can include, e.g., decomposition, analysis, filtering, and reconstruction. During the decomposition step, a wavelet transform (e.g., Discrete Wavelet Transform (DWT)) can be applied to the image. The image is decomposed into different frequency sub-bands (e.g., low-low, low-high, high-low, high-high). During the analysis step, each sub-band is analyzed to identify noise (e.g., high-frequency components), and useful information (e.g., low-frequency components). During the filtering step, filters are applied to each sub-band to remove noise (e.g., thresholding, smoothing), and reserve useful information (e.g., sharpening, enhancing). During the reconstruction step, the image is reconstructed from the filtered sub-bands using an inverse wavelet transform.

In some embodiments, these steps can be handled by an effective object detection machine learning model that is trained on a wide array of examples of weather-related whiteout/low visibility conditions. In some embodiments, the module to control the polarizer's application, whether active or passive, can exist within the perception module and be deployed by the autonomy stack when visibility reduces due to inclement weather. In some embodiments, the system can be operated to allow the vehicle to continue passage along the mission route for continued, extended operation. In some embodiments, the system can be operated to improve visibility while the vehicle seeks to perform a safety maneuver, e.g., a minimal risk condition to pull over on a shoulder or another safe area. The exemplary system therefore provides improved perception to the sensors of the vehicle, ensuring a more accurate guidance of the vehicle can be achieved.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for improving sensor perception, comprising:
at least one sensor configured to be located on a vehicle, wherein the at least one sensor includes a field-of-view;
a polarization unit; and
a processing device in communication with the at least one sensor and the polarization unit, wherein the processing device is configured to execute instructions stored in a memory to perform operations comprising:
detecting, with the at least one sensor, a degraded perception of an environment around the vehicle based on conditions in the environment external to the vehicle; and
actuating the polarization unit to apply a polarization effect to the at least one sensor to improve the degraded perception of the at least one sensor.

2. The system of claim 1, wherein the conditions in the environment include at least one of snow, heavy rain, or sand, in the environment.

3. The system of claim 1, wherein the degraded perception includes reduced visibility of a roadway and/or lane markings on the roadway due to the conditions in the environment.

4. The system of claim 1, wherein the degraded perception includes at least one of blurriness or haziness to the field-of-view of the at least one sensor.

5. The system of claim 1, wherein the operations comprise detecting a luminosity of the environment and determining whether the detected luminosity is above a predetermined luminosity threshold.

6. The system of claim 5, wherein the predetermined luminosity threshold is 400 lux.

7. The system of claim 1, wherein detecting with the at least one sensor a degraded perception of the environment comprises detecting an amount of ambient light received by the at least one sensor and determining whether the detected amount of ambient light received by the at least one sensor is above a predetermined ambient light threshold.

8. The system of claim 1, wherein detecting with the at least one sensor a degraded perception of the environment comprises detecting a continuity value for lane markings on a roadway along which the vehicle is traveling, and determining whether the detected continuity value is above a predetermined continuity value threshold.

9. The system of claim 1, wherein the polarization unit includes a passive polarization filter movably disposed relative to the field-of-view of the at least one sensor.

10. The system of claim 9, wherein the operations comprise moving the passive polarization filter into a deployed position within the field-of-view of the at least one sensor, and moving the passive polarization filter into a stowed position offset from the field-of-view of the at least one sensor.

11. The system of claim 1, wherein the polarization unit includes an active polarization filter capable of being actuated to selectively modify a polarization effect applied to the at least one sensor.

12. The system of claim 11, wherein the operations comprise determining a level of the degraded perception of the environment, and modifying the polarization effect applied by the active polarization filter to the at least one sensor.

13. The system of claim 12, wherein the operations comprise dynamically modifying the polarization effect applied by the active polarization filter to the at least one sensor based on determining of the level of the degraded perception of the environment.

14. The system of claim 13, wherein the polarization effect is dynamically modified in real-time.

15. The system of claim 11, wherein the active polarization filter reduces glare, reflections, and scattered light via polarization filtering, dynamic polarization modulation, and adaptive contrast enhancement.

16. The system of claim 1, wherein the at least one sensor includes a camera.

17. The system of claim 1, wherein the vehicle is an autonomous or a semi-autonomous vehicle.

18. A computer-implemented method for improving sensor perception, comprising:
detecting, with at least one sensor configured to be located on a vehicle, a degraded perception of an environment around the vehicle based on conditions in the environment external to the vehicle; and
executing instructions stored in a memory with a processing device in communication with the at least one sensor and a polarization unit to perform operations comprising:
actuating the polarization unit to apply a polarization effect to the at least one sensor to improve the degraded perception of the at least one sensor.

19. The method of claim 18, wherein the polarization unit includes a passive polarization filter movably disposed relative to the field-of-view of the at least one sensor, and wherein the operations comprise moving the passive polarization filter into a deployed position within the field-of-view of the at least one sensor, and moving the passive polarization filter into a stowed position offset from the field-of-view of the at least one sensor.

20. The method of claim 18, wherein the polarization unit includes an active polarization filter capable of being actuated to selectively modify a polarization effect applied to the at least one sensor, and wherein the operations comprise determining a level of the degraded perception of the environment, and modifying the polarization effect applied by the active polarization filter to the at least one sensor.
